(19) United States
(12) Patent Application Publication
(10) Pub. No.: US 2024/0300233 A1
(43) Pub. Date: Sep. 12, 2024

(54) Automatic Heat Transfer Machine

(71) Applicant: Dongguan Yifei Thermal Transfer Printing Technology Co., LTD., Dongguan City (CN)

(72) Inventor: Zhiyong Zhang, Xiaogan City (CN)

(21) Appl. No.: 18/137,487

(22) Filed: Apr. 21, 2023

(30) Foreign Application Priority Data
Mar. 8, 2023 (CN) 202320433038.2

(51) Int. Cl. B41F 16/00

(52) U.S. Cl. CPC B41F 16/00; B30B 15/34; B41P 2213/11; B41P 2213/202

(57) ABSTRACT

The automatic heat transfer machine includes a base, an upright post and a heat transfer mechanism. The machine is rotatably connected to the base through the upright post, so that the machine can adjust. The machine comprises a shell, a driving motor, a screw, a nut, a connecting component and a heat transfer plate. The shell is provided with a space, and the driving motor, the screw, the nut and the connecting component are all installed in the space. The driving motor drives the screw to rotate. The screw is connected to the nut to change the rotary motion of the screw into the linear motion of the nut. The nut is connected to the heat transfer plate through the connecting component to drive the heat transfer plate to lift. Moreover, in use, the driving motor generates less noise, thereby improving the user experience.

### CROSS REFERENCE TO RELATED APPLICATION

This application takes priority from and claims the benefit of Chinese Patent Application No. 202320433038.2, filed on Mar. 8, 2023, the contents of which are herein incorporated by reference.

### TECHNICAL FIELD

The present disclosure relates to the technical field of heat transfer printing, in particular to an automatic heat transfer machine.

### BACKGROUND

The existing automatic heat transfer machine is mainly pneumatic (compressed gas controls a cylinder to extend and retract) and hydraulic (an oil pump supplies hydraulic oil to drive an oil cylinder to extend or retract). For example, a pneumatic heat transfer machine needs not only power supply, but also air source (an air pump) and an air storage cylinder in use. The volume of the machine is relatively large, and the noise generated by the air pump is large during use, which reduces the user experience.

### SUMMARY

Based on this, it is necessary to provide an automatic heat transfer machine, which aims to solve the technical problems that a pneumatic heat transfer machine needs not only power supply, but also air source (an air pump) and an air storage cylinder in use, the volume of the machine is relatively large, and the noise generated by the air pump is large during use, which reduces the user experience.

The present disclosure provides an automatic heat transfer machine, comprising abase, an upright post and a heat transfer mechanism, wherein the heat transfer mechanism is rotatably connected to the base through the upright post, the heat transfer mechanism comprises a shell, a driving motor, a screw, a nut, a connecting component and a heat transfer plate component, the shell is provided with an accommodating space, the driving motor, the screw, the nut and the connecting component are all installed in the accommodating space, the driving motor is connected with the screw and is used to drive the screw to rotate, the screw is in threaded connection with the nut so as to change the rotary motion of the screw into the linear motion of the nut, and the nut is connected with the heat transfer plate component through the connecting component so as to drive the heat transfer plate component to lift.

In one embodiment, the connecting component comprises a pressing plate and a connecting post, the nut is installed on the pressing plate, and the connecting post is slidably connected with the pressing plate and is connected with the heat transfer plate component.

In one embodiment, the heat transfer mechanism further comprises a guide rod, and the guide rod is installed on the wall surface of the accommodating space and penetrates through the pressing plate to guide the pressing plate to lift.

In one embodiment, a plurality of guide rods are circumferentially provided at intervals around the pressing plate.

In one embodiment, the connecting component further comprises an elastic element, and the elastic element is sleeved with the connecting post and is elastically abutted between the pressing plate and the heat transfer plate component.

In one embodiment, the connecting post comprises a sliding rod and an abutting part connected to the sliding rod, the sliding rod is slidably connected with the pressing plate, and the abutting part is capable of being abutted against the pressing plate.

In one embodiment, a plurality of connecting posts are circumferentially provided at intervals around the pressing plate, and a plurality of elastic elements are provided in one-to-one correspondence with the connecting posts.

In one embodiment, the shell comprises a body and a protective cover connected with the body, and the screw, the nut and the connecting component are all provided in the protective cover.

In one embodiment, the automatic heat transfer machine further comprises a workbench and a handheld element, the handheld element is connected with the workbench, the workbench is slidably connected with the base, and the handheld element is pulled to drive the workbench to slide with respect to the base.

In one embodiment, the automatic heat transfer machine further comprises a silica gel pad, and the silica gel pad is installed on the workbench.

The implementation of the embodiment of the present disclosure has the following beneficial effects.

The automatic heat transfer machine of the present disclosure is used. The heat transfer mechanism of the automatic heat transfer machine is rotatably connected to the base through the upright post, so that the heat transfer mechanism can rotate with respect to the upright post, and the heat transfer mechanism can adjust the position. The heat transfer mechanism comprises a shell, a driving motor, a screw, a nut, a connecting component and a heat transfer plate component. The driving motor, the screw, the nut and the connecting component are all installed in the accommodating space of the shell, so as to protect the driving motor, the screw, the nut and the connecting component. The driving motor is connected with the screw and is used to drive the screw to rotate. The screw is in threaded connection with the nut so as to change the rotary motion of the screw into the linear motion of the nut. The nut is connected with the heat transfer plate component through the connecting component so as to drive the heat transfer plate component to lift, so that heat transfer can be carried out. The driving motor, the screw and the nut are provided, so that an air pump and an air storage cylinder in the conventional means can be replaced, and the volume of the automatic heat transfer machine can be reduced. Moreover, in use, the driving motor generates less noise, thereby improving the user experience.

### BRIEF DESCRIPTION OF THE DRAWINGS

In order to explain the embodiments of the present disclosure or the technical scheme in the prior art more clearly, the drawings needed in the embodiments or the description of the prior art will be briefly introduced hereinafter. Obviously, the drawings in the following description are only some embodiments of the present disclosure. For those skilled in the art, other drawings can be obtained according to these drawings without creative work.

In the drawings:

FIG. 1 is an axonometric schematic diagram of an automatic heat transfer machine according to one embodiment.

FIG. 2 is a schematic diagram of a heat transfer mechanism in an automatic heat transfer machine rotating with respect to a base as shown in FIG. 1.

FIG. 3 is a schematic diagram of a workbench in an automatic heat transfer machine moving with respect to a base as shown in FIG. 2.

FIG. 4 is a top view of an automatic heat transfer machine as shown in FIG. 1.

FIG. 5 is a cross-sectional view of A-A in an automatic heat transfer machine as shown in FIG. 4.

FIG. 6 is a cross-sectional view of hot stamping products in which a heat transfer plate component is in contact with a silica gel pad in an automatic heat transfer machine as shown in FIG. 5.

Reference numerals: 1. Base; 11. Guide groove; 2. Upright post; 3. Heat transfer mechanism; 31. Shell; 311. Body; 312. Protective cover; 32. Driving motor; 33. Screw; 34. Connecting component; 342. Pressing plate; 343. Connecting post; 3431. Sliding rod; 3432. Abutting part; 344. Guide rod; 345. Elastic element; 35. Heat transfer plate component; 36. Control panel; 37. Nut; 4. Worktable; 41. Guide rail; 5. Handheld element; 6. Silica gel pad; 100. Accommodating space.

### DETAILED DESCRIPTION OF THE EMBODIMENTS

The technical scheme in the embodiment of the present disclosure will be described clearly and completely in conjunction with the attached drawings in the embodiment of the present disclosure. Obviously, the described embodiments are only some of the embodiments of the present disclosure, rather than all of the embodiments. Based on the embodiments in the present disclosure, all other embodiments obtained by those skilled in the art without creative work belong to the protection scope of the present disclosure.

It should be noted that similar symbols and letters indicate similar items in the following drawings, so that once an item is defined in one drawing, the item does not need to be further defined and explained in subsequent drawings.

In the description of the present disclosure, it should be noted that the orientational or positional relationships indicated by the terms such as “up”, “down”, “left”, “inside” and “outside” are based on the orientational or positional relationships shown in the drawings or the orientational or positional relationships that the product of the present disclosure is usually placed in use only for the convenience of describing the present disclosure and simplifying the description, rather than indicate or imply that the referred devices or elements must have a specific orientation, be constructed and operated in a specific orientation, and therefore should not be construed as limiting the present disclosure.

In addition, the terms such as “first” and “second” are only used for distinguishing description, and cannot be understood as indicating or implying relative importance.

It should be noted that the features in the embodiments of the present disclosure can be combined with each other without conflict.

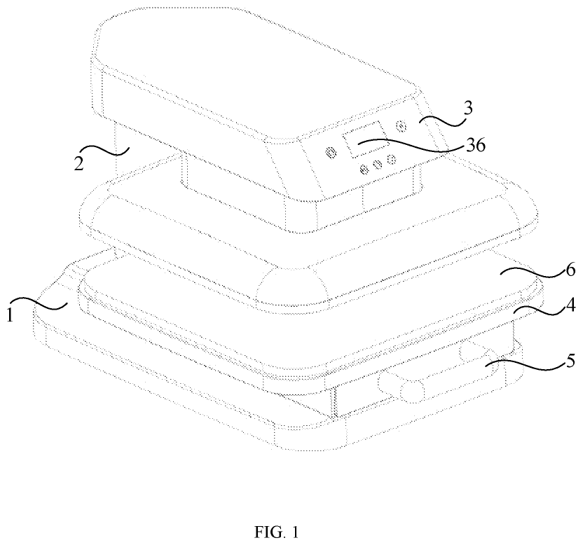

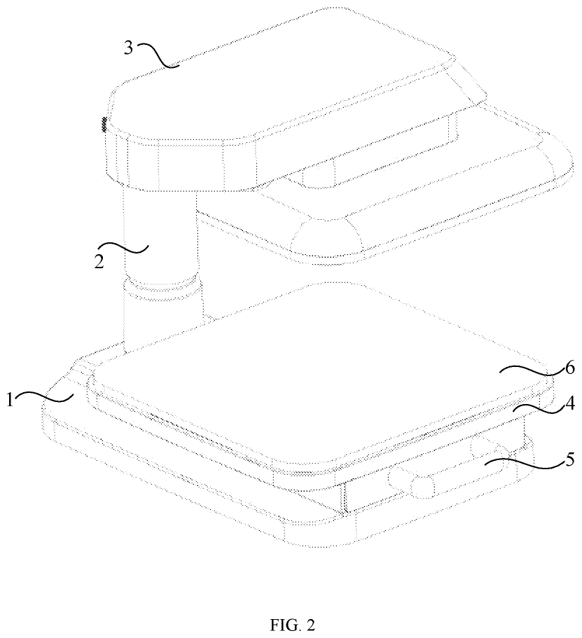

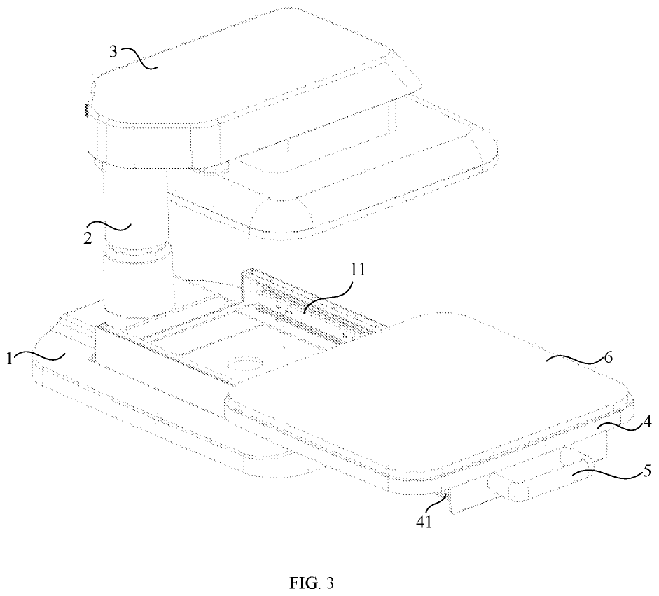

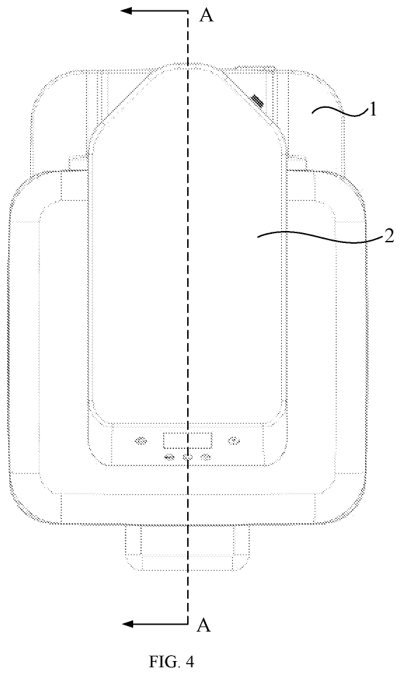

As shown in FIG. 1 to FIG. 6, the automatic heat transfer machine provided by the present disclosure is explained. The automatic heat transfer machine comprises a base 1, an upright post 2 and a heat transfer mechanism 3. The heat transfer mechanism 3 is rotatably connected to the base 1 through the upright post 2. The heat transfer mechanism 3 comprises a shell 31, a driving motor 32, a screw 33, a nut 37, a connecting component 34 and a heat transfer plate component 35. The shell 31 is provided with an accommodating space 100. The driving motor 32, the screw 33, the nut 37 and the connecting component 34 are all installed in the accommodating space 100. The driving motor 32 is connected with the screw 33 and is used to drive the screw 33 to rotate. The screw 33 is in threaded connection with the nut 37 so as to change the rotary motion of the screw 33 into the linear motion of the nut 37. The nut 37 is connected with the heat transfer plate component 35 through the connecting component 34 so as to drive the heat transfer plate component 35 to lift.

It can be understood that the heat transfer mechanism 3 of the automatic heat transfer machine is rotatably connected to the base 1 through the upright post 2, so that the heat transfer mechanism 3 can rotate with respect to the upright post 2, and the heat transfer mechanism 3 can adjust the position. The heat transfer mechanism 3 comprises a shell 31, a driving motor 32, a screw 33, a nut 37, a connecting component 34 and a heat transfer plate component 35. The driving motor 32, the screw 33, the nut 37 and the connecting component 34 are all installed in the accommodating space 100 of the shell 31, so as to protect the driving motor 32, the screw 33, the nut 37 and the connecting component 34. The driving motor 32 is connected with the screw 33 and is used to drive the screw 33 to rotate. The screw 33 is in threaded connection with the nut 37 so as to change the rotary motion of the screw 33 into the linear motion of the nut 37. The nut 37 is connected with the heat transfer plate component 35 through the connecting component 34 so as to drive the heat transfer plate component 35 to lift, so that heat transfer can be carried out. The driving motor 32, the screw 33 and the nut 37 are provided, so that an air pump and an air storage cylinder in the conventional means can be replaced, and the volume of the automatic heat transfer machine can be reduced. Moreover, in use, the driving motor 32 generates less noise, thereby improving the user experience. In addition, the automatic heat transfer machine can avoid air leakage after long-term use and is suitable for use in home environment.

In this embodiment, the connecting component 34 comprises a pressing plate 342 and a connecting post 343. The nut 37 is mounted on the pressing plate 342. The connecting post 343 is slidably connected with the pressing plate 342 and is connected with the heat transfer plate component 35. Specifically, the driving motor 32 drives the screw 33 to rotate. The screw 33 is in threaded connection with the nut 37 so as to change the rotary motion of the screw 33 into the linear motion of the nut 37. In this way, the nut 37 can drive the pressing plate 342 to lift. The pressing plate 342 drives the pressing plate component 35 to lift through the connecting post 343, so that the pressing plate component 35 can carry out heat transfer on products.

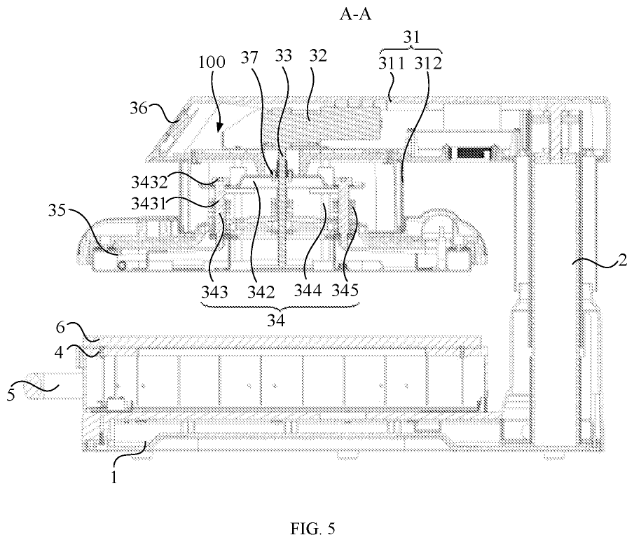

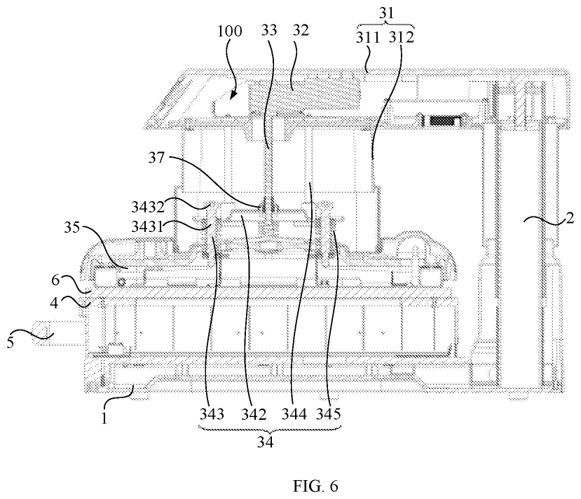

In an embodiment, as shown in FIGS. 5 and 6, the heat transfer mechanism 3 further comprises a guide rod 344. The guide rod 344 is installed on the wall surface of the accommodating space 100 and penetrates through the pressing plate 342 to guide the pressing plate 342 to lift. The guide rod 344 is provided. In this way, the moving path of the pressing plate 342 can be guided during the lifting of the pressing plate 342, so that the heat transfer plate component 35 can be lifted along the moving path.

In this embodiment, a plurality of guide rods 344 are circumferentially provided at intervals around the pressing plate 342. A plurality of guide rods 344 are provided, so that the pressing plate 342 moves more smoothly.

In an embodiment, with continued reference to FIGS. 5 and 6, the connecting component 34 further comprises an elastic element 345. The elastic element 345 is sleeved with the connecting post 343 and is elastically abutted between the pressing plate 342 and the heat transfer plate component 35. Specifically, the elastic element 345 can be a spring. The spring is sleeved with the connecting post 343. In the heat transfer process of the heat transfer plate component 35, the elastic element 345 can play a buffering role, so that the hot stamping product will not be damaged.

In this embodiment, the connecting post 343 comprises a sliding rod 3431 and an abutting part 3432 connected to the sliding rod 3431. The sliding rod 3431 is slidably connected with the pressing plate 342, and the abutting part 3432 is capable of being abutted against the pressing plate 342.

Specifically, in a normal state of the elastic element 345, both ends of the elastic element 345 are abutted against the pressing plate 342 and the heat transfer plate component 35, respectively, so that the abutting part 3432 is capable of being abutted against the pressing plate 342. In the heat transfer process of the heat transfer plate component 35, under the acting force of the workbench 4, the heat transfer plate component 35 drives the sliding rod 3431 to move with respect to the pressing plate 342, and the abutting part 3432 is not abutted against the pressing plate 342. At this time, the heat transfer plate component 35 and the pressing plate 342 squeeze the elastic element 345. The heat transfer plate component 35 transmits the acting force to the elastic element 345, so that the heat transfer plate component 35 can play a buffering role, thereby avoiding excessive pressure on the hot stamping products and protecting the hot stamping products.

Further, a plurality of connecting posts 343 are circumferentially provided at intervals around the pressing plate 342, and a plurality of elastic elements 345 are provided in one-to-one correspondence with the connecting posts 343. A plurality of connecting posts 343 are provided, so that in the heat transfer process of the heat transfer plate component 35, under the acting force of the workbench 4, the heat transfer plate component 35 can move more stably. A plurality of elastic elements 345 are provided, so that the buffering exerted by the elastic elements 345 is more stable, thereby improving the heat transfer effect of the heat transfer plate component 35.

In an embodiment, with continued reference to FIGS. 5 and 6, the shell 31 comprises a body 311 and a protective cover 312 connected with the body 311, and the screw 33, the nut 37 and the connecting component 34 are all provided in the protective cover 312. Specifically, the protective cover 312 is telescopic, so that in the movement process of the nut 37 and the connecting component 34, the protective cover 312 can extend and retract with the movement of the nut 37 and the connecting component 34, thereby protecting the screw 33, the nut 37 and the connecting component 34.

In an embodiment, as shown in FIGS. 1, 2, 3, 5 and 6, the automatic heat transfer machine further comprises a workbench 4 and a handheld element 5. The handheld element 5 is connected with the workbench 4. The workbench 4 is slidably connected with the base 1. The handheld element 5 is pulled to drive the workbench 4 to slide with respect to the base 1.

Specifically, the workbench 4 is provided with a guide rail 41. The base 1 is provided with a guide groove 11. The guide rail 41 is slidably connected with the groove wall of the guide groove 11. The handheld element 5 is pulled so that the workbench 4 can slide with respect to the base 1. In this manner, the hot stamping products can be placed on the workbench 4 or removed from the workbench 4.

In one embodiment, with continued reference to FIGS. 1, 2, 3, 5 and 6, the automatic heat transfer machine further comprises a silica gel pad 6. The silica gel pad 6 is installed on the workbench 4. The silica gel pad 6 can resist high temperature. The silica gel pad 6 is provided, so that the hot stamping products are not in direct contact with the workbench 4. In this way, the heat transfer plate component 35 can protect the hot stamping products during heat transfer. In addition, the silica gel pad 6 can also play a role in heat insulation, so as to avoid transferring heat to the workbench 4.

In an embodiment, as shown in FIGS. 1 to 3, the heat transfer mechanism 3 further comprises a control panel 36. The control panel 36 is exposed on the shell 31. The control panel 36 can control the heat transfer temperature and time of the heat transfer plate component 35.

The workflow of the present disclosure is as follows. After the automatic heat transfer machine is powered on, the temperature and time are set on the control panel 36. When the temperature rises to the set value, the heat transfer mechanism 3 rotates with respect to the upright post 2, or the handheld element 5 is pulled so that the workbench 4 slides with respect to the base 1. The hot stamping products are then placed on the silica gel pad 6, and then the workbench 4 is pushed to the original position, or the heat transfer mechanism 3 rotates directly above the workbench 4.

The start button on the control panel 36 is pressed. The driving motor 32 drives the screw 33 to rotate counterclockwise. The screw 33 drives the nut 37, the connecting component 34 and the heat transfer plate component 35 to move close to the hot stamping products. Finally, the heat transfer plate component 35 compresses and presses the hot stamping products for heat transfer. After the hot stamping time, the control panel 36 controls the driving motor 32 to drive the screw 33 to rotate clockwise. The screw 33 then drives the nut 37, the connecting component 34 and the heat transfer plate component 35 to move away from the hot stamping products. Subsequently, the heat transfer mechanism 3 rotates with respect to the upright post 2, or the handheld element 5 is pulled to slide the workbench 4 with respect to the base 1. The products which have carried out hot stamping are taken out, and the hot stamping operation ends.

The technical features of the embodiments described above can be combined arbitrarily. In order to make the description concise, not all possible combinations of the technical features in the embodiments described above are described. However, as long as there is no contradiction between the combinations of these technical features, they should be considered as the scope recorded in this specification.

What has been disclosed above is only the preferred embodiment of the present disclosure, and of course cannot be used to limit the scope of claims of the present disclosure. Therefore, the equivalent changes made according to the claims of the present disclosure still fall within the scope covered by the present disclosure.

What is claimed is:

1. An automatic heat transfer machine, comprising a base, an upright post and a heat transfer mechanism, wherein the heat transfer mechanism is rotatably connected to the base through the upright post, the heat transfer mechanism comprises a shell, a driving motor, a screw, a nut, a connecting component and a heat transfer plate component, the shell is provided with an accommodating space, the driving motor, the screw, the nut and the connecting component are all installed in the accommodating space, the driving motor is connected with the screw and is used to drive the screw to rotate, the screw is in threaded connection with the nut so as to change the rotary motion of the screw into the linear motion of the nut, and the nut is connected with the heat transfer plate component through the connecting component so as to drive the heat transfer plate component to lift.

2. The automatic heat transfer machine according to claim 1, wherein the connecting component comprises a pressing plate and a connecting post, the nut is installed on the pressing plate, and the connecting post is slidably connected with the pressing plate and is connected with the heat transfer plate component.

3. The automatic heat transfer machine according to claim 2, wherein the heat transfer mechanism further comprises a guide rod, and the guide rod is installed on the wall surface of the accommodating space and penetrates through the pressing plate to guide the pressing plate to lift.

4. The automatic heat transfer machine according to claim 3, wherein a plurality of guide rods are circumferentially provided at intervals around the pressing plate.

5. The automatic heat transfer machine according to claim 2, wherein the connecting component further comprises an elastic element, and the elastic element is sleeved with the connecting post and is elastically abutted between the pressing plate and the heat transfer plate component.

6. The automatic heat transfer machine according to claim 5, wherein the connecting post comprises a sliding rod and an abutting part connected to the sliding rod, the sliding rod is slidably connected with the pressing plate, and the abutting part is capable of being abutted against the pressing plate.

7. The automatic heat transfer machine according to claim 5, wherein a plurality of connecting posts are circumferentially provided at intervals around the pressing plate, and a plurality of elastic elements are provided in one-to-one correspondence with the connecting posts.

8. The automatic heat transfer machine according to claim 1, wherein the shell comprises a body and a protective cover connected with the body, and the screw, the nut and the connecting component are all provided in the protective cover.

9. The automatic heat transfer machine according to claim 1, wherein the automatic heat transfer machine further comprises a workbench and a handheld element, the handheld element is connected with the workbench, the workbench is slidably connected with the base, and the handheld element is pulled to drive the workbench to slide with respect to the base.

10. The automatic heat transfer machine according to claim 9, wherein the automatic heat transfer machine further comprises a silica gel pad, and the silica gel pad is installed on the workbench.
